(19) United States
(12) Patent Application Publication
(10) Pub. No.: US 2019/0312461 A1
(43) Pub. Date: Oct. 10, 2019

(54) Method and System of Cooperative Charging Between an Unmanned Aerial Vehicle and an Unmanned Surface Vessel

(71) Applicant: Guangdong Institute of Industrial Technology, Huazhong University of Science and Technology, Dongguan (CN)

(72) Inventors: Haitao Zhang, Hubei (CN); Binbin Hu, Hubei (CN); Bin Liu, Hubei (CN); Zhiguo Cao, Hubei (CN); Jin Zhao, Hubei (CN); Housheng Su, Hubei (CN); Zhecheng Xu, Hubei (CN); Junfeng Ge, Hubei (CN); Tao Geng, Dongguan (CN)

(73) Assignee: Guangdong Institute of Industrial Technology, Huazhong University of Science

(21) Appl. No.: 16/178,914

(22) Filed: Nov. 2, 2018

(30) Foreign Application Priority Data
Apr. 8, 2018 (CN) 201810305966.4

(51) Int. Cl. H02J 50/12; H02J 7/06; G05D 1/10; G06T 7/70; G06T 7/20; B64C 39/02

(52) U.S. Cl. CPC H02J 50/12; H02J 7/06; G05D 1/101; H02J 2007/10; G06T 7/20; B64C 39/024; G06T 7/70

(57) ABSTRACT

A method and system for cooperative charging between an unmanned aerial vehicle and an unmanned surface vessel includes: using the unmanned aerial vehicle to capture an image of the unmanned surface vessel; analyzing the relative position of a capturing device and the velocity of the unmanned surface vessel; controlling the unmanned aerial vehicle to approach the capturing device, and making the unmanned aerial vehicle to hover at a certain height within the capture range; detecting whether the unmanned aerial vehicle is within the capture range and, if within the range, using the unmanned surface vessel to capture the unmanned aerial vehicle or using the unmanned aerial vehicle to re-capture an image of the unmanned surface vessel; using the capturing device to adjust the position of the unmanned aerial vehicle and performing wireless charging.

### FIELD OF THE INVENTION

The invention relates to unmanned application technology and, in particular, to a method and system of cooperative charging between an unmanned aerial vehicle and an unmanned surface vessel.

### BACKGROUND OF THE INVENTION

As a kind of aircraft that is powered, controllable, capable of carrying multi-functional devices, performing multiple tasks and being reusable, the unmanned aerial vehicle can be widely used in monitoring, surveillance and other fields. However, it is limited by battery capacity and charging technology. The continuous working hours of an unmanned aerial vehicle are extremely short, making its applications greatly restricted. After flying a period of time, the unmanned aerial vehicle must return for power replenishment. Such replenishment of most existing unmanned aerial vehicles is done by replacing the battery or substituting in for charging. Such an operation is troublesome and cannot realize the full automation.

Therefore, it is imperative to provide a method and device to solve the above-mentioned problem.

### SUMMARY OF THE INVENTION

In view of the foregoing, an objective of the invention is to provide a method and system of cooperative charging between an unmanned aerial vehicle and an unmanned surface vessel.

The disclosed method includes the steps of:

using the unmanned aerial vehicle to capture an image of the unmanned surface vessel, and analyzing the relative position of a capturing device of the unmanned surface vessel and the moving velocity of the unmanned surface vessel;

controlling the unmanned aerial vehicle to approach the capturing device and making the unmanned aerial vehicle to hover at a specific height with a capture range;

detecting whether the unmanned aerial vehicle is within the capture range and, if so, using the unmanned surface vessel to capture the unmanned aerial vehicle or using the unmanned aerial vehicle to re-capture the image of the unmanned surface vessel; and

using the capturing device to adjust the position of the unmanned aerial vehicle and charging the unmanned aerial vehicle in a wireless way.

The step of using the unmanned aerial vehicle to capture an image of the unmanned surface vessel, and analyzing the relative position of a capturing device of the unmanned surface vessel and the moving velocity of the unmanned surface vessel further includes the steps of:

capturing the images of the unmanned surface vessel in an adjusting area at a specific time interval Δt;

identifying the position of the unmanned surface vessel in the image and the location of a tagging point of the capturing device, and analyzing the relative position of the tagging point on the unmanned surface vessel;

differentially computing the relative displacement Δy=y_{t+Δt}=yₜ of the tagging point according to the relative position of the tagging point in the captured image, where yₜ denotes the relative position of the tagging point at time t and y_{t+Δt} denotes that at Δt later; and

using the relative displacement to obtain the moving velocity v=Δy/Δt of the unmanned surface vessel.

The step of controlling the unmanned aerial vehicle to approach the capturing device further includes the steps of:

computing an error of the relative position of the tagging point with respect to the unmanned aerial vehicle according to the relative position of the tagging point, the moving velocity of the unmanned surface vessel, and the location of unmanned aerial vehicle from the global positioning system;

deriving and substituting the error into the kinematic equation associated with the unmanned aerial vehicle, and establishing a position error tracking model;

designing a control algorithm for the unmanned aerial vehicle to obtain an expected velocity for the unmanned aerial vehicle to reach an expected trajectory;

substituting the difference between the expected velocity and the current velocity into the dynamical model associated with the unmanned aerial vehicle, and using a feedback control method to obtain expected roll angle R, pitch angle P, and yaw angle Y;

substituting the roll angle R, the pitch angle P, and the yaw angle Y into an equation of angles and motor control value of the unmanned aerial vehicle and solving for the motor control value for the unmanned aerial vehicle; and

adjusting motor control value for the unmanned aerial vehicle so that the unmanned aerial vehicle approaches the capturing device at the expected velocity.

Furthermore, the control algorithm is selected from the group consisting of the double closed-loop PID control algorithm, intelligent PID algorithm, LQR algorithm, nonlinear H infinite control algorithm, robust control method and sliding mode control algorithm.

Moreover, the step of making the unmanned aerial vehicle to hover at a specific height with a capture range further includes the steps of:

checking the height of the unmanned aerial vehicle h and analyzing the difference Δh with an expected capturing height h_{d};

using Δh to design the feedback control algorithm and obtaining control parameters Kp, Ki, Kd for the height of the unmanned aerial vehicle, where Kp is a ratio adjusting coefficient for adjusting a response speed, Ki is an integral adjusting coefficient for adjusting the static error, and Kd is a differential adjusting coefficient for adjusting oscillations; and

continuously adjusting control parameters so that the unmanned aerial vehicle hovers within the capture range at a specific height from the unmanned surface vessel.

The step of detecting whether the unmanned aerial vehicle is within the capture range and, if so, using the unmanned surface vessel to capture the unmanned aerial vehicle or using the unmanned aerial vehicle to re-capture the image of the unmanned surface vessel further includes the steps of:

detecting whether the unmanned aerial vehicle is within the capture range through an infrared sensor or camera on the capturing device;

initiating a servo of the capturing device if the unmanned aerial vehicle is within the capture range, and controlling a crank slider to move along a linear track for the capturing device to capture the unmanned aerial vehicle; and

re-capturing an image of the unmanned surface vessel if the unmanned aerial vehicle is not within the capture range.

The step of using the capturing device to adjust the position of the unmanned aerial vehicle and charging the unmanned aerial vehicle in a wireless way further includes the steps of:

using the capturing device to move the unmanned aerial vehicle right above the charging coil of the unmanned surface vessel, and aligning the coil of the unmanned aerial vehicle with the charging coil;

connecting a power supply to the emitting end of a wireless charging device, converting the power into AC power through a wireless charging board, and emitting the power via an emitting coil of the unmanned surface vessel; and

using a reception coil of the unmanned aerial vehicle to receive power, and using the wireless charging board to charge the battery of the unmanned aerial vehicle first at constant current then at constant voltage.

The disclosed system of an unmanned aerial vehicle and an unmanned surface vessel for cooperative charging includes:

an unmanned aerial vehicle;

an unmanned surface vessel for charging the unmanned aerial vehicle in a wireless way; and

a capturing device installed on the unmanned surface vessel for capturing and moving the unmanned aerial vehicle to the charging place of the unmanned surface vessel;

wherein the unmanned aerial vehicle analyzes a relative position of the capturing device on the unmanned surface vessel and the moving velocity of the unmanned surface vessel, and hovers within a capture range.

The unmanned aerial vehicle is provided with a charging reception coil and a wireless charging board. The capturing device is provided with a crank slider, a barb with a connecting device, an infrared sensor, a servo and a linear track. After the infrared sensor detects the position of the unmanned aerial vehicle, the unmanned surface vessel initiates the servo to slide the crank slider along the linear track, so that the barb with a connecting device captures the unmanned aerial vehicle. The unmanned surface vessel is provided with a charging device, and the charging device includes a charging board and a charging coil.

Furthermore, the unmanned aerial vehicle is a multi-rotor unmanned aerial vehicle. The unmanned surface vessel is a double-propeller unmanned surface vessel, a single-propeller unmanned surface vessel with a tail rudder, or a fully driven unmanned surface vessel with a side thrust device.

The invention provides a method and a system of an unmanned aerial vehicle and an unmanned surface vessel for charging in a cooperative way. By utilizing the cooperative control technology of the unmanned aerial vehicle and the unmanned surface vessel, the large-capacity battery on the unmanned surface vessel is used to charge the unmanned aerial vehicle. It greatly improves the continuous operation ability and range of the unmanned aerial vehicle, and concurrently solves the problem of manual participation for charging the unmanned aerial vehicle. It realizes full automation of the unmanned aerial vehicle.

### BRIEF DESCRIPTION OF THE DRAWINGS

FIG. 1 is a schematic view of the system structure according to an embodiment of the invention.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

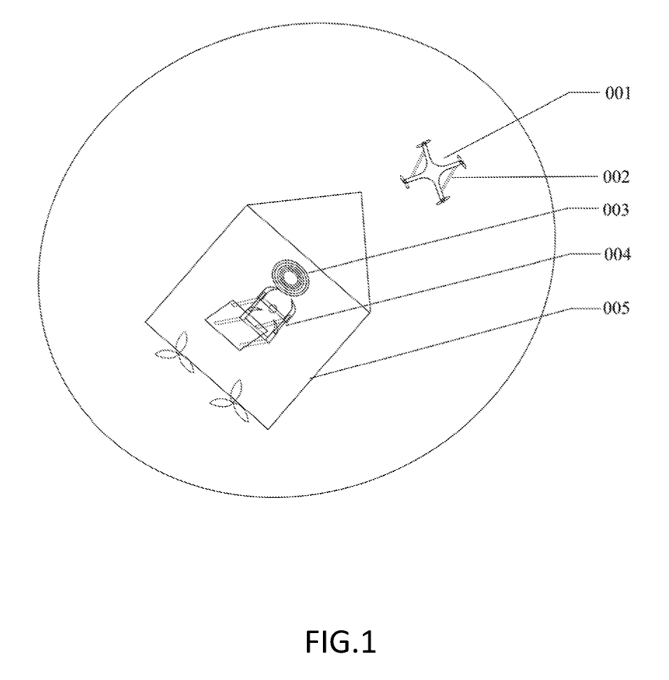

As shown in FIG. 1, the disclosed method of an unmanned aerial vehicle and an unmanned surface vessel for cooperative charging includes the steps of: using an unmanned aerial vehicle 001 to capture an image of an unmanned surface vessel 005 in an adjusting area, identifying the position of the unmanned surface vessel 005 in the image and the position of a tagging point of a capturing device 004, and analyzing the relative position of the tagging point on the unmanned surface vessel 005; identifying the relative position of the tagging point in the captured image according to a time interval Δt, differentially computing a relative displacement Δy=y_{t+Δt}−yₜ of the tagging point, where yₜ denotes the relative position of the tagging point at time t, y_{t+Δt} denotes the relative position of the tagging point after the time interval Δt. The relative displacement is then used to derive the moving velocity of the unmanned surface vessel, v=Δy/Δt.

According to the relative position of the tagging point, the moving velocity of the unmanned surface vessel 005 and the GPS information of the unmanned aerial vehicle 001, the error of the relative position between the unmanned aerial vehicle 001 and the tagging point is calculated. The error is then substituted into the kinematic equation of the unmanned aerial vehicle 001 to establish a position error tracking model. By analyzing the error model and using the theories of Lyapunov principle, Barbalet lemma, and LaSalle invariant set, the disclosed method combines feedback and feedforward control designs for stability analysis, thereby deriving a control law for the unmanned aerial vehicle 001 to approach the expected velocity in a stable manner. The expected velocity for the unmanned aerial vehicle 001 as to reach the desired trajectory is thus obtained. The difference between the expected velocity and the current velocity is substituted into the dynamics model of the unmanned aerial vehicle 001. A feedback control method is used to obtain a desired roll angle R, pitch angle P, and yaw angle Y of the unmanned aerial vehicle 001. Here the roll angle R is used to control the lateral moving speed of the unmanned aerial vehicle, the pitch angle P is used to control the forward moving speed of the unmanned aerial vehicle, and the yaw angle Y is used to control the spin of the unmanned aerial vehicle.

The roll angle R, the pitch angle P, and the yaw angle Y are substituted into an equation of angle and motor control conversion equation of the unmanned aerial vehicle 001, thereby obtaining a motor control value of the unmanned aerial vehicle 001. The motor control value of the unmanned aerial vehicle 001 is then adjusted to make the unmanned aerial vehicle approach the capturing device 004 at the expected velocity.

An ultrasonic sensor or air pressure gauge is used to derive the height h of the unmanned aerial vehicle 001, thereby calculating the error Δh between h and a predefined capture height h_{d}. Using Δh a feedback control algorithm (preferably the PID control algorithm) is designed to obtain control parameters Kp, Ki, and Kd for the height of the unmanned aerial vehicle 001, where Kp is a ratio adjusting coefficient for adjusting a response speed, Ki is an integral adjusting coefficient for adjusting the static error, and Kd is a differential adjusting coefficient for adjusting oscillations. Such controls are imposed to the motor of the unmanned aerial vehicle 001. When the unmanned aerial vehicle 001 is higher than the designated height, the control is reduced. When the unmanned aerial vehicle 001 is lower than the designated height, the control is increased. Eventually, the unmanned aerial vehicle 001 is controlled to hover within a specific range of height.

The infrared sensor or camera on the capturing device 004 is used to detect whether the unmanned aerial vehicle is within the capture range. If so, the servo of the capturing device 004 is activated to move along a linear track by controlling a crank slider, so that the capturing device 004 can capture an unmanned aerial vehicle frame 002. If it is not within the capture range, the image of the unmanned surface vessel 005 is re-captured.

The capturing device 004 moves the unmanned aerial vehicle 001 right above the charging coil of the unmanned surface vessel 005, and aligns the coil of the unmanned aerial vehicle 001 with the charging coil. The power is connected to the transmitting end of the wireless charging device 003. The wireless charging board converts the power into an alternating current, and transmits the energy through a transmitting coil of the unmanned surface vessel. The receiving coil of the unmanned aerial vehicle receives the energy. Through the wireless charging coil, the batter of the unmanned aerial vehicle is first charged at a constant current then at a constant voltage.

In this embodiment, the control algorithm includes the dual closed-loop PID control algorithm, the intelligent PID algorithm, the LQR algorithm, the nonlinear H infinite control algorithm, the robust control method, and the sliding mode control algorithm. The above algorithms may be selected to be combined to establish a tracking kinematics model of the unmanned aerial vehicle 001. Control parameters of the unmanned aerial vehicle 001 are computed and adjusted so that the unmanned aerial vehicle 001 hovers at a specific height over the capturing position.

In this embodiment, all control algorithms are independently completed by the unmanned aerial vehicle 001 and the unmanned surface vessel 005. The capturing device 004 is positioned and identified by the camera during the approach. Finally, the unmanned aerial vehicle hovers within a certain height range. The unmanned surface vessel identifies the unmanned aerial vehicle within the capture range. The capturing device 004 is manipulated to capture the unmanned aerial vehicle 001 and then move it above the charging coil. In comparison with the usual method for the unmanned aerial vehicle 001 to automatically hover above the charging position, the disclosed method ensures the precision in the positioning of the unmanned aerial vehicle and the accuracy in the charging position. It effectively overcomes the problems of drifting, low positioning precision, and fluctuations in the hovering height of the unmanned aerial vehicle. Since the unmanned surface vessel 005 works in a water environment and is equipped with a large-capacity battery, it can effectively increase the operation time and operation range of monitoring and patrol of the unmanned surface vessel 005 and the unmanned aerial vehicle 001 in a cooperative way. It effectively solves the problems of a small battery capacity of the unmanned aerial vehicle. At the same time, the wireless charging method between the unmanned aerial vehicle and the unmanned surface vessel in a cooperative way does not require manual intervention. It can realize the full automation of the unmanned aerial vehicle 001 and the unmanned surface vessel 005.

As shown in FIG. 1, the disclosed system of an unmanned aerial vehicle and an unmanned surface vessel for cooperative charging includes: an unmanned aerial vehicle 001, an unmanned surface vessel 005 for charging the unmanned aerial vehicle in a wireless way, and a capturing device 004 installed on the unmanned surface vessel 005 for capturing and moving the unmanned aerial vehicle to the charging place of the unmanned surface vessel; wherein the unmanned aerial vehicle 002 analyzes a relative position of the capturing device 004 on the unmanned surface vessel 005 and the moving velocity of the unmanned surface vessel 005, and hovers within a capture range. The unmanned aerial vehicle 001 is provided with a charging reception coil and a wireless charging board. The capturing device 004 is installed on the unmanned aerial vehicle 001 and is provided with a crank slider, a barb with a connecting device, an infrared sensor, a servo and a linear track. The unmanned surface vessel is provided with a charging device 003, and the charging device 003 includes a charging board and a charging coil.

In this embodiment, the unmanned aerial vehicle 001 is a multi-rotor unmanned aerial vehicle. The unmanned surface vessel 005 is a double propeller unmanned surface vessel, a single propeller unmanned surface vessel with a tail rudder, or a fully driven unmanned surface vessel with a side thrust device.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A method of cooperative charging between an unmanned aerial vehicle and an unmanned surface vessel, comprising the steps of:
using the unmanned aerial vehicle to capture an image of the unmanned surface vessel, and analyzing the relative position of a capturing device of the unmanned surface vessel and the moving velocity of the unmanned surface vessel;
controlling the unmanned aerial vehicle to approach the capturing device and making the unmanned aerial vehicle to hover at a specific height with a capture range;
detecting whether the unmanned aerial vehicle is within the capture range and, if so, using the unmanned surface vessel to capture the unmanned aerial vehicle or using the unmanned aerial vehicle to re-capture the image of the unmanned surface vessel; and
using the capturing device to adjust the position of the unmanned aerial vehicle and charging the unmanned aerial vehicle in a wireless way.

2. The method of claim 1, wherein the step of using the unmanned aerial vehicle to capture an image of the unmanned surface vessel, and analyzing the relative position of a capturing device of the unmanned surface vessel and the moving velocity of the unmanned surface vessel further includes the steps of:
capturing the images of the unmanned surface vessel in an adjusting area at a specific time interval Δt;
identifying the position of the unmanned surface vessel in the image and the location of a tagging point of the capturing device, and analyzing the relative position of the tagging point on the unmanned surface vessel;
differentially computing the relative displacement Δy=y_{t+Δt}−yₜ of the tagging point according to the relative position of the tagging point in the captured image, where yₜ denotes the relative position of the tagging point at time t and y_{t+Δt} denotes that at Δt later; and
using the relative displacement to obtain the moving velocity v=Δy/Δt of the unmanned surface vessel.

3. The method of claim 1, wherein the step of controlling the unmanned aerial vehicle to approach the capturing device further includes the steps of:
computing an error of the relative position of the tagging point with respect to the unmanned aerial vehicle according to the relative position of the tagging point, the moving velocity of the unmanned surface vessel, and the location of unmanned aerial vehicle from the global positioning system;
deriving and substituting the error into the kinematic equation associated with the unmanned aerial vehicle, and establishing a position error tracking model;
designing a control algorithm for the unmanned aerial vehicle to obtain an expected velocity for the unmanned aerial vehicle to reach an expected trajectory;
substituting the difference between the expected velocity and the current velocity into the dynamical model associated with the unmanned aerial vehicle, and using a feedback control method to obtain expected roll angle R, pitch angle P, and yaw angle Y;
substituting the roll angle R, the pitch angle, and the yaw angle Y into an equation of angles and motor control value of the unmanned aerial vehicle and solving for the motor control value for the unmanned aerial vehicle; and
adjusting motor control value for the unmanned aerial vehicle so that the unmanned aerial vehicle approaches the capturing device at the expected velocity.

4. The method of claim 3, wherein the control algorithm is selected from the group consisting of the double closed-loop PID control algorithm, intelligent PID algorithm, LQR algorithm, nonlinear H infinite control algorithm, robust control method and sliding mode control algorithm.

5. The method of claim 1, wherein the step of:
checking the height of the unmanned aerial vehicle h and analyzing the difference Δh between h and an expected capturing height h_{d};
using Δh to design the feedback control algorithm and obtaining control parameters Kp, Ki, Kd for the height of the unmanned aerial vehicle, where Kp is a ratio adjusting coefficient for adjusting a response speed, Ki is an integral adjusting coefficient for adjusting the static error, and Kd is a differential adjusting coefficient for adjusting oscillations; and
continuously adjusting control parameters so that the unmanned aerial vehicle hovers within the capture range at a specific height from the unmanned surface vessel.

6. The method of claim 1, wherein the step of detecting whether the unmanned aerial vehicle is within the capture range and, if so, using the unmanned surface vessel to capture the unmanned aerial vehicle or using the unmanned aerial vehicle to re-capture the image of the unmanned surface vessel further includes the steps of:
detecting whether the unmanned aerial vehicle is within the capture range through an infrared sensor or camera on the capturing device;
initiating a servo of the capturing device if the unmanned aerial vehicle is within the capture range, and controlling a crank slider to move along a linear track for the capturing device to capture the unmanned aerial vehicle; and
re-capturing an image of the unmanned surface vessel if the unmanned aerial vehicle is not within the capture range.

7. The method of claim 1, wherein the step of using the capturing device to adjust the position of the unmanned aerial vehicle and charging the unmanned aerial vehicle in a wireless way further includes the steps of:
using the capturing device to move the unmanned aerial vehicle right above the charging coil of the unmanned surface vessel, and aligning the coil of the unmanned aerial vehicle with the charging coil;
connecting a power supply to the emitting end of a wireless charging device, converting the power into AC power through a wireless charging board, and emitting the power via an emitting coil of the unmanned surface vessel; and
using a reception coil of the unmanned aerial vehicle to receive power, and using the wireless charging board to charge the battery of the unmanned aerial vehicle first at constant current then at constant voltage.

8. A system of cooperative charging between an unmanned aerial vehicle and an unmanned surface vessel, comprising:
an unmanned aerial vehicle;
an unmanned surface vessel for charging the unmanned aerial vehicle in a wireless way; and
a capturing device installed on the unmanned surface vessel for capturing and moving the unmanned aerial vehicle to the charging place of the unmanned surface vessel;
wherein the unmanned aerial vehicle analyzes a relative position of the capturing device on the unmanned surface vessel and the moving velocity of the unmanned surface vessel, and hovers within a capture range; the unmanned aerial vehicle is provided with a charging reception coil and a wireless charging board; the capturing device is provided with a crank slider, a barb with a connecting device, an infrared sensor, a servo and a linear track; after the infrared sensor detects the position of the unmanned aerial vehicle, the unmanned surface vessel initiates the servo to slide the crank slider along the linear track, so that the barb with a connecting device captures the unmanned aerial vehicle; and the unmanned surface vessel is provided with a charging device that includes a charging board and a charging coil.

9. The system of claim 8, wherein the unmanned aerial vehicle is a multi-rotor unmanned aerial vehicle; and the unmanned surface vessel is a double-propeller unmanned surface vessel, a single-propeller unmanned surface vessel with a tail rudder, or a fully driven unmanned surface vessel with a side thrust device.
